(19) United States
(12) Patent Application Publication
(10) Pub. No.: US 2024/0347899 A1
(43) Pub. Date: Oct. 17, 2024

(54) ANTENNA DEVICE AND VEHICLE ANTENNA DEVICE

(71) Applicant: AGC Inc., Tokyo (JP)

(72) Inventors: Toshiki SAYAMA, Tokyo (JP); Hideaki SHOJI, Tokyo (JP); Yusuke KATO, Tokyo (JP)

(73) Assignee: AGC Inc., Tokyo (JP)

(21) Appl. No.: 18/754,136

(22) Filed: Jun. 25, 2024

Related U.S. Application Data
(63) Continuation of application No. PCT/JP2022/047783, filed on Dec. 23, 2022.

(30) Foreign Application Priority Data
Dec. 28, 2021 (JP) 2021-214890

(51) Int. Cl. H01Q 1/32; H01Q 1/12; H01Q 1/48; H01Q 9/04

(52) U.S. Cl. CPC H01Q 1/3208; H01Q 1/1271; H01Q 1/48; H01Q 9/0407

(57) ABSTRACT

An antenna device comprises a dielectric substrate, an antenna including a radiation plate and a ground conductor plate, a connector, and cover member. A position of a feeding point on the radiation plate is different to a position of a centroid of the radiation plate in front view of the antenna, and the antenna and the cover member cover a periphery of the connector when the antenna, the connector, and the cover member are viewed along a direction orthogonal to a first straight line connecting the centroid to the feeding point and orthogonal to a thickness direction of the dielectric substrate.

### CROSS-REFERENCE TO RELATED APPLICATIONS

This application is a continuation of International Application No. PCT/JP2022/047783, filed on Dec. 23, 2022, which claims priority from Japanese Patent Application No. 2021-214890, filed on Dec. 28, 2021. The entire disclosure of each of the above applications is incorporated herein by reference.

### BACKGROUND

### Technical Field

The present disclosure relates to an antenna device and a vehicle antenna device.

### Related Art

In accordance with recently improved levels of self-driving, there is a tendency to install vehicles with a communication system to implement Vehicle to Everything (V2X), such as vehicle-to-vehicle communication and roadside-to-vehicle communication. Vehicles installed with a V2X communication system utilize, for example, vertically polarized radio waves in a narrow-band range of a 5.8 GHz band or a 5.9 GHz band, and there is a demand for V2X antennas with antenna gain and directionality to satisfying a V2X communication standard so as to be able to acquire various safety related information from outside the vehicle.

In a V2X antenna there is a demand for directionality that implements a desired gain over a range of) ±90° (180° in a horizontal plane, for example centered on a vehicle forward direction (progression direction). There is no limitation to where such V2X antennas are disposed, as long as they are able to implement the desired antenna gain and directionality.

Japanese Patent Application Laid-Open (JP-A) No. 2019-75644 and International Publication (WO) No. 2019/163521 disclose antenna devices including a radiation face on the vehicle inside that faces toward a windshield or toward a rear glass, with the antenna device configured for use as an onboard antenna for V2X communication. In such antenna devices, electrical feed to the radiation plate (radiation conductor) is performed from one end portion of a transmission line such as a coaxial cable or the like, and signal control in the antenna device is performed by an electrical control unit (ECU) connected to a portion at the other end of the transmission line.

Onboard antenna devices described in JP-A No. 2019-75644 and WO No. 2019/163521 include a coaxial PCB connector that is attached to a casing for internally housing a patch antenna and that includes a metal member, and so there is a concern that this metal member might cause changes to the directionality of the antenna and that the desired antenna gain might no longer be implementable.

### SUMMARY

In consideration of the above circumstances, an object of the present disclosure is to provide an antenna device and vehicle antenna device that contain a structure in which a connector including a metal member is used to connect a transmission line to an antenna, and that are capable of implementing a desired antenna gain and directionality.

An antenna device according to the present disclosure includes: a dielectric substrate; an antenna including a radiation plate that is provided on a first main face of the dielectric substrate and that includes a radiation face radiating radio waves of a prescribed frequency band, and including a ground conductor plate that is disposed on a second main face of the dielectric substrate; a connector that is provided to a face of the ground conductor plate on an opposite side from a radiation plate side, that includes a metal member, that is fixed to the antenna, and that supports a transmission line; and a cover member that opposes a face of the ground conductor plate on the opposite side from the radiation plate side and that is configured from an electrically grounded conductor. A position of a feeding point on the radiation plate that is a location where power is supplied from the transmission line is different from a position of a centroid of the radiation plate, in a front view of the antenna, and the antenna and the cover member cover a periphery of the connector when the antenna, the connector, and the cover member are viewed along a direction orthogonal to a first straight line connecting the centroid to the feeding point and orthogonal to a thickness direction of the dielectric substrate.

The antenna device and vehicle antenna device according to the present disclosure include a structure in which a connector including a metal member is used to connect a transmission line to an antenna, and are capable of implementing a desired antenna gain and directionality.

### BRIEF DESCRIPTION OF DRAWINGS

Exemplary embodiments of the present invention will be described in detail based on the following figures, wherein:

FIG. 1 is a plan view illustrating a vehicle antenna device according to a present exemplary embodiment of the present disclosure, as viewed from a vertical direction of the vehicle applied with the vehicle antenna device;

FIG. 2 is a schematic cross-section of a front section of a vehicle and a rear section of the vehicle;

FIG. 3 is a perspective view of an antenna device, illustrated with a second connector and a coaxial cable omitted;

FIG. 4 is a front view of an antenna device;

FIG. 5 is a cross-section of an antenna device taken along arrow line 5-5 of FIG. 3;

FIG. 6 is a cross-section of an antenna device taken along arrow line 6-6 of FIG. 4 and FIG. 5;

FIG. 7 is a perspective view of an assembled structure of a first connector, a second connector, and a coaxial cable;

FIG. 8 is a diagram illustrating measurement results of directionality of vehicle antenna devices of an Example 1 that is a working example and an Example 2 that is a comparative example; and

FIG. 9 is a back view of a vehicle antenna device similar to FIG. 7 according to a modified example of the present disclosure.

### DETAILED DESCRIPTION

Description follows regarding a vehicle antenna device 40 according to an exemplary embodiment of the present disclosure, with reference to the appended drawings. As described later, the vehicle antenna device 40 of the present exemplary embodiment is provided to a vehicle 10. As appropriate in the drawings, an X axis is parallel to a vehicle width direction of the vehicle 10, a Y axis is parallel to a vehicle front-rear direction, and a Z axis is a “vertical direction” parallel to a vehicle up-down direction. Furthermore, an arrow FR indicates forward in the vehicle front-rear direction, an arrow UP indicates upward in the vehicle up-down direction, and an arrow LF indicates left in the vehicle width direction. An XY plane is a plane passing through the X axis and the Y axis, and is also called a “horizontal plane”. Namely, in the following description the vehicle 10 is positioned on a horizontal plane, with the vehicle up-down direction aligned with the vertical direction, with the XY plane aligned with a horizontal plane, and with the vertical direction corresponding to a normal direction with respect to the horizontal plane. Furthermore, an XZ plane is a plane passing through the X axis and the Z axis, and a YZ plane is a plane passing through the Y axis and the Z axis.

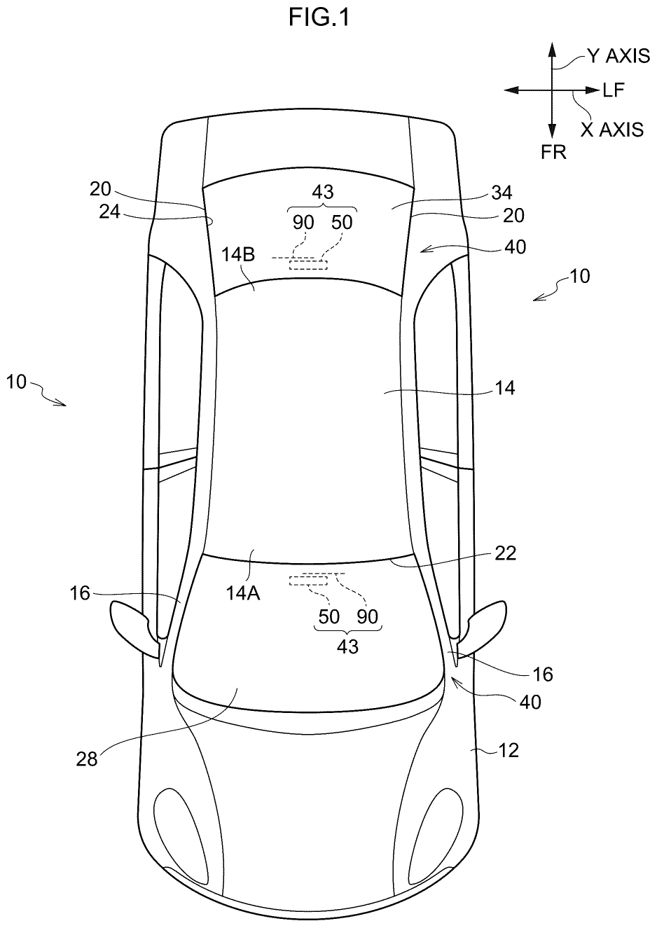

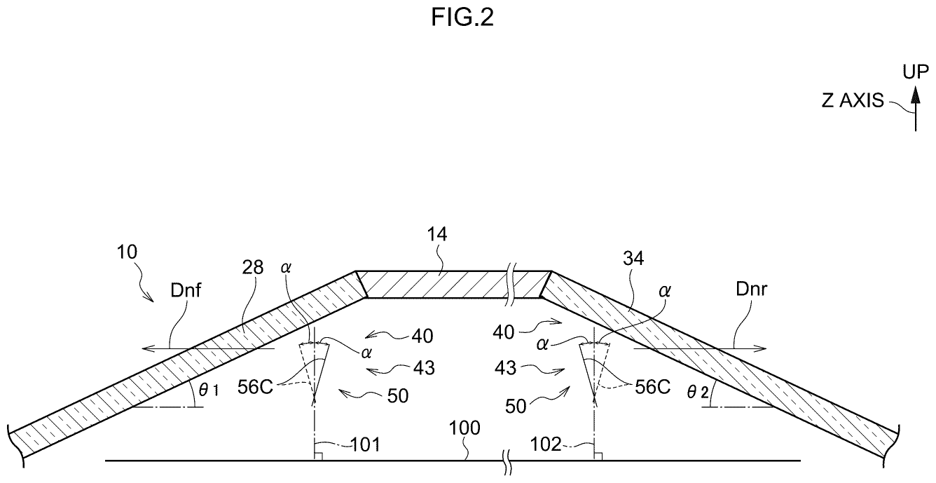

FIG. 1 is a plan view illustrating a vehicle antenna device according to the present exemplary embodiment, as viewed from a vertical direction of the vehicle mounted with the vehicle antenna device, and FIG. 2 is a schematic cross-section of a front section of the vehicle and a rear section of the vehicle. As illustrated in FIG. 1, the vehicle 10 includes a vehicle body 12 containing a metal body, and the metal body includes, for example, a roof section 14, A pillars (front pillars) 16, and C pillars (rear pillars) 20.

A substantially quadrangular shaped forward opening 22 is formed in a front section of the vehicle body 12. An upper edge portion of the forward opening 22 is adjacent to a front edge portion 14A of the roof section 14, and left and right side edge portions of the forward opening 22 are adjacent to the left and right A-pillars 16. A windshield (vehicle window glass) 28 is fitted to the forward opening 22, and peripheral edge portions of the windshield 28 are fixed to peripheral edge portions of the forward opening 22 with an adhesive such as a urethane resin or the like. As illustrated in FIG. 2, the windshield 28 is, in side view (along the X axis direction), inclined at an angle θ1 with respect to an XY plane 100 corresponding to a horizontal plane, such that a lower end portion thereof is positioned further forward than the upper end portion thereof.

A substantially quadrangular shaped rearward opening 24 is formed at a rear section of the vehicle body 12. An upper edge portion of the rearward opening 24 is adjacent to the rear edge portion 14B of the roof section 14, and left and right side edge portions of the rearward opening 24 are adjacent to the left and right C-pillars 20. A rear glass (vehicle window glass) 34 is fitted to the rearward opening 24, with peripheral edge portions of the rear glass 34 fixed to peripheral edge portions of the rearward opening 24 with an adhesive such as a urethane resin or the like. As illustrated in FIG. 2, the rear glass 34 is, in side view (along the X axis direction), inclined at an angle θ2 with respect to the XY plane 100 corresponding to a horizontal plane such that a lower end portion thereof is positioned further rearward than an upper end portion thereof.

Furthermore, as illustrated in FIG. 1 and FIG. 2, a communication antenna 50 is attached to a vehicle up-down direction upper portion of a main face of the windshield 28 through a bracket, omitted in the drawings. The communication antenna 50 is, as illustrated in FIG. 2, attached such that a normal direction Dnf to a radiation face 56C extends in a forward direction from the radiation face 56C and passes out through the windshield 28. Note that the normal direction Dnf in FIG. 2 is a normal direction with respect to the radiation face 56C when an inclination angle α, described later, is 0°. Furthermore, a communication antenna 50 is, as illustrated in FIG. 2, attached such that a normal direction Dnr to a radiation face 56C extends in a rearward direction from a radiation face 56C thereof and passes out through the rear glass 34. Note that the normal direction Dnr of FIG. 2 is a normal direction with respect to the radiation face 56C when an inclination angle α, described later, is 0°.

Configuration elements of the vehicle antenna device 40 include a vehicle window glass, such as the windshield 28, the rear glass 34, or the like, the communication antenna 50, a first connector 70, a second connector 80, a coaxial cable (transmission line) 90, and a cover member 95. Furthermore, configuration elements of an antenna device 43 include the communication antenna 50, the first connector 70, the second connector 80, the coaxial cable 90, and the cover member 95. Note that the first connector 70 and the second connector 80 may be configured as separate bodies, or may be integrally manufactured. In the present specification reference simply to “connector” includes both a configuration in which the first connector 70 and the second connector 80 are separate bodies, and an integrally manufactured configuration, and means a fixture to connect the transmission line (coaxial cable 90) and the communication antenna 50 together.

The coaxial cable 90 is an example of a transmission line for transmitting a radio signal, and other examples of the transmission line include a microstrip line, a strip line, a coplanar waveguide, a grounded coplanar waveguide (GCPW), a coplanar strip, a slot line, a waveguide, and the like. In the present specification, the transmission line is described as a structure including the coaxial cable 90, unless explicitly stated otherwise. The communication antenna 50 of the present exemplary embodiment is a vertically polarized wave antenna having a higher antenna gain for transmitting and receiving vertically polarized waves than for horizontally polarized waves. The V2X antenna described below is particularly an antenna that is capable of transmitting and receiving using vertically polarized waves and that is able to utilize radio waves in the 5.8 GHz band or radio waves in the 5.9 GHz band.

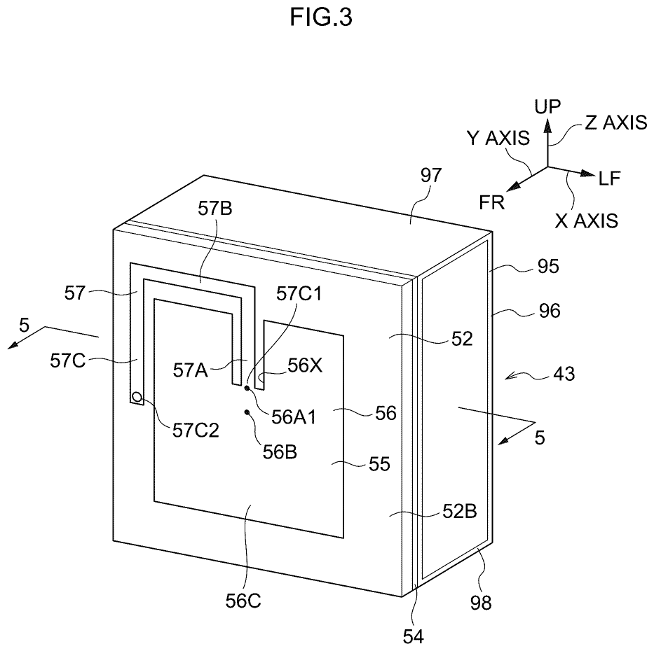

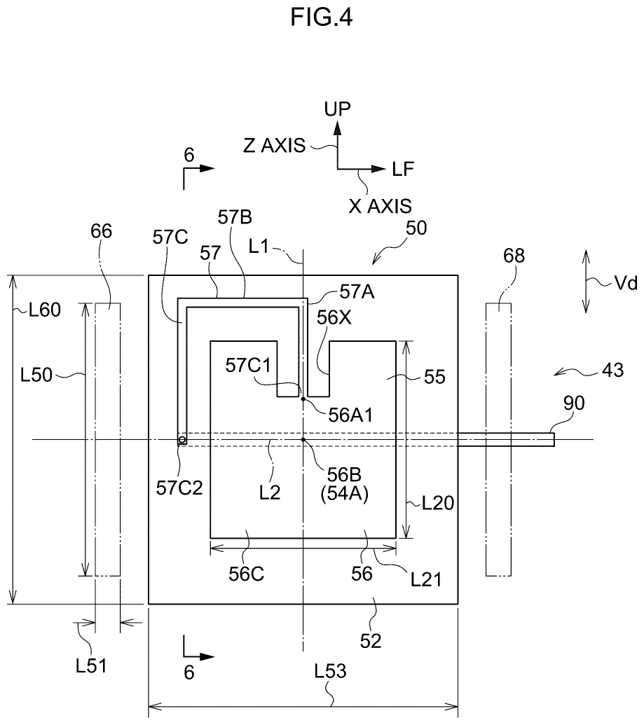

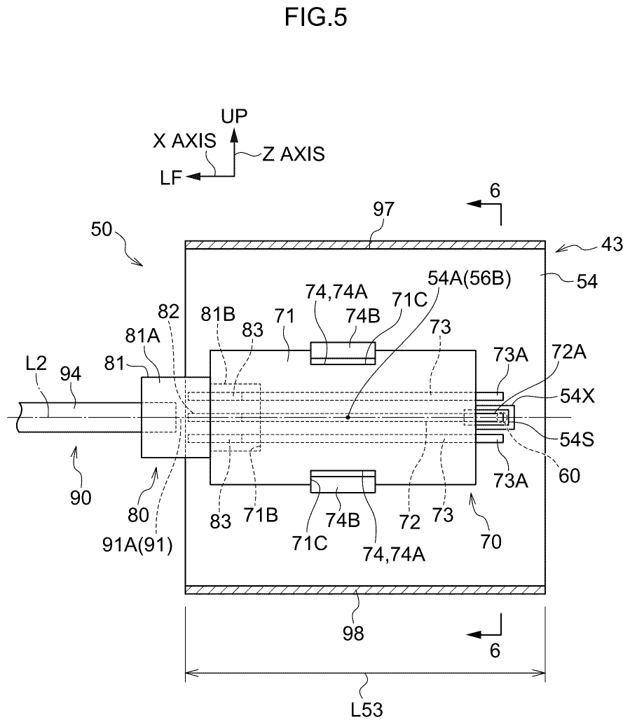

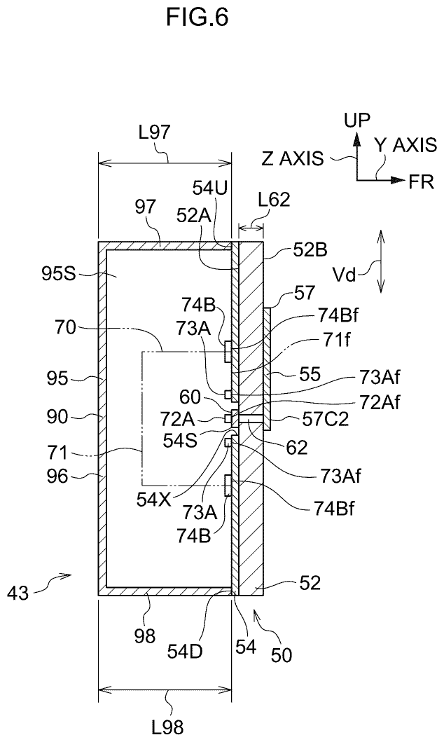

Next, description follows regarding the antenna device 43 and the communication antenna 50 (hereinafter simply referred to as “antenna 50”) in the vehicle antenna device 40 according to the present exemplary embodiment. FIG. 3 and FIG. 4 are respectively a perspective view and a front view of the antenna device 43. FIG. 5 is a cross-section of the antenna device 43 taken along “5-5” of FIG. 3, and FIG. 6 is a cross-section of the antenna device 43 taken along “6-6” of FIG. 4 and FIG. 5.

As illustrated in FIG. 6, the antenna 50 of the present exemplary embodiment includes a dielectric substrate 52, a first conductor plate 54, a second conductor plate 55, a feeding portion 60, and a connecting conductor 62. Moreover, as illustrated in FIG. 3 and FIG. 4, the first conductor plate 54 is a ground conductor plate 54 at a ground electrical potential, and the second conductor plate 55 includes the radiation plate 56 and a planar shaped conductor line (transmission line) 57. However, the second conductor plate 55 does not necessarily include the planar shaped conductor line 57, and may be configured by the radiation plate 56 alone. Moreover, examples of materials to configure the first conductor plate 54 and the second conductor plate 55 include, for example, copper and silver, however there is no limitation thereto.

Thus the antenna 50 of the present exemplary embodiment is a patch antenna (microstrip antenna). Although the antenna 50 according to the present exemplary embodiment is, for example, capable of being utilized as the V2X antenna described above, it may be configured so as to be capable of transmitting and receiving linearly polarized waves of a frequency band different from those described above.

As illustrated in FIG. 3 and FIG. 6, the radiation plate 56 having a smaller surface area than the first conductor plate 54 is provided to a main face 52B of the dielectric substrate 52. The second conductor plate 55 is a planar shaped layer. The shape of the radiation plate 56 in front view is a substantially rectangular shape (square shape). Namely, the radiation plate 56 has a profile including a cut out 56X formed to an upper edge portion of a rectangular shape in front view, however a cut out 56X may be formed to a lower edge portion of the rectangle instead of to the upper edge portion. Note that “front view” in the present specification means when the antenna 50 is being viewed along the Y axis direction (thickness direction of the dielectric substrate 52).

The radiation plate 56 illustrated in FIG. 3 and FIG. 4 includes a feeding point 56A1 provided at a position in the vicinity of a bottom portion of the cut out 56X. The shape of the planar shaped conductor line 57 in front view is a substantially J-shape. Namely, the planar shaped conductor line 57 is itself different from the coaxial cable 90 but is part of a transmission line, and is formed to the main face 52B of the dielectric substrate 52 to electrically supply a radio signal to the feeding point 56A1.

The planar shaped conductor line 57 is formed with the J-shape including a first portion 57A extending upward from the bottom portion of the cut out 56X of the radiation plate 56, a second portion 57B extending to the right side from an upper end portion of the first portion 57A, and a third portion 57C extending downward from an upper end portion of the second portion 57B. A first end portion 57C1 for connecting to the feeding point 56A1 is provided to a lower end portion of the first portion 57A, and a second end portion 57C2 is provided to a lower end portion of the third portion 57C. Note that as illustrated in FIG. 3 and FIG. 4, the feeding point 56A1 is separated from the centroid 56B of the radiation plate 56 in front view of the antenna 50.

Moreover, as illustrated in FIG. 4, in front view of the antenna 50, taking a first straight line L1 that passes through the feeding point 56A1 and the centroid 56B, the antenna 50 radiates linearly polarized waves that vibrate along the first straight line L1. For example, the antenna 50 is designed so as to radiate linearly polarized waves in a 5.8 GHz band or 5.9 GHz band and, if the direction of the linearly polarized waves is a vertical direction, functions in the vehicle antenna device 40 as a V2X antenna that transmits and receives vertically polarized waves.

Moreover, as illustrated in FIG. 4, the antenna 50 may be equipped with one or other, or both, out of a first element 66 or a second element 68, which are parasitic conductor plates. The first element 66 and the second element 68 are independent conductor plates and are not connected to a signal line 91 or to an earth line of an external conductor 93 or the like, which are internal conductors of the coaxial cable 90. Examples of materials for configuring the first element 66 and the second element 68 include, for example, copper and silver, however there is no limitation thereto. Note that although the first element 66 and the second element 68 in FIG. 4 have rectangular shapes in front view of the antenna 50, they may have a shape other than a rectangular shape. However, the antenna gain in the X axis direction (vehicle width direction) is raised in the vehicle antenna device 40 if the shapes of the first element 66 and the second element 68 are shapes that in front view extend along the Z axis direction.

In cases in which the antenna 50 includes the first element 66 and the second element 68, they may separated from each other in the vehicle width direction (horizontal direction) in the vehicle antenna device 40, and may be separated from the dielectric substrate 52 in the X axis direction. Namely, as illustrated in FIG. 4, in front view of the antenna 50, the first element 66 and the second element 68 are disposed at the outside of the ground conductor plate 54. In such cases, the first element 66 and the second element 68, which are parasitic conductor plates, may be disposed at positions different from the centroid 56B in front view of the antenna 50. Moreover, the radiation plate 56 (the centroid 56B) may be positioned between the first element 66 and the second element 68 in front view of the antenna 50.

Furthermore, although omitted from illustration, the first element 66 and the second element 68 are disposed in the same plane as the main face 52B of the dielectric substrate 52 when the antenna 50 is viewed along the Z axis. However, the first element 66 and the second element 68 may be disposed on the opposite side of a main face 52A from the radiation face 56C side thereof, and may be disposed at a position in the same plane as the main face 52A but not in contact with the ground conductor plate 54. Note that the main face 52B and the main face 52A of the dielectric substrate 52 are respectively a first main face and a second main face of the dielectric substrate 52. In cases in which the first element 66 and the second element 68 are disposed in a different plane from the radiation plate 56 and the ground conductor plate 54, at least one of the first element 66 or the second element 68 may partly or entirely overlap with the ground conductor plate 54 in front view of the antenna 50, and may partly overlap other than at the centroid 56B of the radiation plate 56.

The dielectric substrate 52 is a plate shaped or film shaped dielectric layer, and is typically a cuboidal shaped dielectric layer. However, such “plate shaped or film shaped” may include, for example, portions having a protruding shape, indented shape, or wavy shape. This similarly applies to the ground conductor plate 54, the radiation plate 56, the first element 66, and the second element 68, and these may be formed in a thin planar shape typically thinner in thickness than the dielectric layer. When these members are planar shaped then this facilitates prediction of antenna gain characteristics of the antenna 50.

Moreover, although the front view shape of the dielectric substrate 52 illustrated in FIG. 4 is a square shape, it may be a rectangular shape longer in dimension in the X axis direction than in the Z axis direction, and may be a freely selected shape such as a polygonal shape other than a rectangular shape, a circular shape, or a shape including a curved outer edge. The dielectric substrate 52 includes the main face 52A on one thickness direction side, and the main face 52B parallel to the main face 52A. The dielectric substrate 52 may be formed using, for example, a glass epoxy board. Note that when the front view shape of the dielectric substrate 52 is a rectangular shape long in a direction orthogonal to the straight line L1 (the vehicle width direction) then this enables placement regions for the first element 66 and second element 68 to be secured on at least one main face out of the main face 52A or the main face 52B of the dielectric substrate 52.

Next, description follows regarding each member disposed on the main face 52A of the dielectric substrate 52. As illustrated in FIG. 5 and FIG. 6, the ground conductor plate 54, and a signal relay portion 54S, are provided on the main face 52A of the dielectric substrate 52. The signal relay portion 54S is electrically connected to the feeding portion 60, and also configures part of the transmission line. As illustrated in FIG. 5, an external edge of the ground conductor plate 54 has a square shape. Moreover, a quadrangular shaped opening 54X is formed inside the ground conductor plate 54, with the signal relay portion 54S provided at the inside of an inner peripheral face of the opening 54X. Namely, the ground conductor plate 54 and the signal relay portion 54S are separated and do not make contact with each other. Note that the external edge of the opening 54X is not limited to being a quadrangular shape, and may be a freely selected shape other than a quadrangular shape.

The feeding portion 60 is connected to the signal relay portion 54S, and is also electrically connected to a one end portion 91A of the signal line 91 of the coaxial cable 90. Note that an end portion on the opposite side of the signal line 91 from the end portion 91A is connected to a control device for controlling a signal of the antenna 50, and an end portion on the opposite side of the external conductor 93 from the one end portion 91A should be grounded.

As illustrated in FIG. 6, the connecting conductor 62 contained in the antenna 50 is a conductor pin provided inside a through hole piercing through the dielectric substrate 52 in the plate thickness direction thereof. One end of the connecting conductor 62 is not in contact with the ground conductor plate 54 and is connected to the feeding portion 60, with the other end thereof connected to the second end portion 57C2 of the planar conductor line 57. Moreover, as illustrated in FIG. 3 and FIG. 4, the feeding point 56A1 corresponding to an end portion on the opposite side of the planar conductor line 57 from the second end portion 57C2 is separated in front view from the centroid 56B of the radiation plate 56. As illustrated in FIG. 4 and FIG. 5, the centroid 56B and the centroid 54A of the ground conductor plate 54 overlap with each other in front view of the antenna 50.

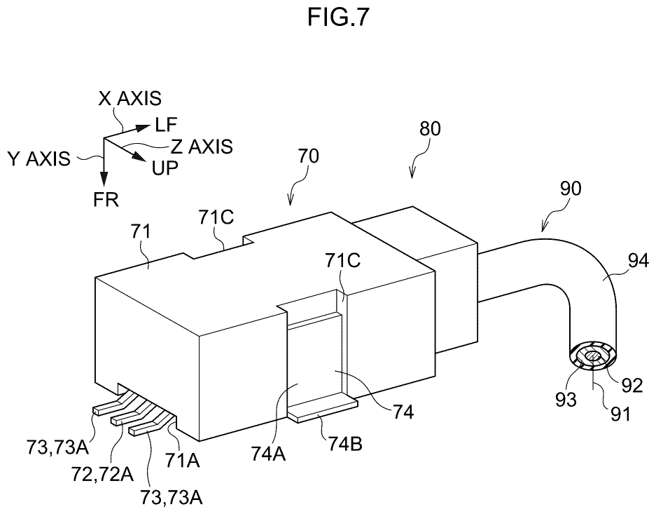

FIG. 7 is a perspective view illustrating an assembled structure of the first connector 70, the second connector 80, and the coaxial cable 90. As illustrated in FIG. 5 and FIG. 6, the first connector (connector) 70 is fixed to a main face on the opposite side of the ground conductor plate 54 from the second conductor plate 55 side in a state in which fixing members 74 are in contact with this main face. The first connector 70 includes an insulator 71, and includes a signal contact (transmission line) (metal member) 72, a ground contact (transmission line) (metal member) 73, and the fixing members (metal members) 74 that each contain a metal material as respective configuring materials thereof. The insulator 71 is configured by an insulating material such as a resin or the like. A face of the insulator 71 that opposes the first conductor plate 54 is a plane parallel to the main face of the first conductor plate 54.

In the assembled structure illustrated in FIG. 7, a cut out 71A is formed to a lower end portion of a right end face of the insulator 71. Moreover, as illustrated in FIG. 5, a recess 71B is formed to a left end face of the insulator 71. Furthermore, as illustrated in FIG. 5 and FIG. 6, recess grooves 71C are formed at left-right direction central portions of an upper face and lower face of the insulator 71. A single signal contact 72 and two ground contacts 73 that all contain a metal material as a configuring material thereof are provided in the interior of the insulator 71.

As illustrated in FIG. 5, the signal contact 72 and the ground contacts 73 extend in straight lines along the X axis direction in front view of the antenna 50. Furthermore, as illustrated in FIG. 5 to FIG. 7, right end portions of the signal contact 72 and the ground contacts 73 include tail portions 72A, 73A positioned further forward than other locations of the signal contact 72 and the ground contacts 73.

Moreover, as illustrated in FIG. 5 and FIG. 7, the fixing members 74 that are metal plates each having an L-shape in cross-section profile are press-fitted into the upper and lower recess grooves 71C. The fixing members 74 each include a main body portion 74A press-fitted into the recess groove 71C, and a tale portion 74B extending from a front end portion of the main body portion 74A in a direction orthogonal to the main body portion 74A. As illustrated in FIG. 6, a front face 71f of the insulator 71, a front face 72Af of the tail portion 72A, front faces 73Af of the tail portions 73A, and front faces 74Bf of the tale portions 74B are all positioned in a single plane.

In the first connector 70, in a state in which the insulator 71 contacts the ground conductor plate 54, the tale portion 74B of each of the fixing members 74 is fixed by solder or the like to the ground conductor plate 54, and the first connector 70 is fixed to the antenna 50. When the first connector 70 has been fixed to the antenna 50, as illustrated in FIG. 6, the tail portions 73A of the two ground contacts 73 connect to the ground conductor plate 54 through solder or the like, and the front face 72A of the signal contact 72 connects to the signal relay portion 54S through solder or the like.

The recess 71B of the first connector 70 includes a structure enabling attachment or detachment of the second connector 80 illustrated in FIG. 5 and FIG. 6. The second connector 80 includes an insulator 81, and includes a signal contact (transmission line) (metal member) 82 and ground contacts (transmission line) (metal members) 83 that all contain metal material as respective configuring materials. The insulator 81 is configured from an insulating material such as a resin or the like. The insulator 81 includes a main body 81A and a connection portion 81B that protrudes out toward the right side from a right end face of the main body 81A. A through hole (omitted in the drawings) is formed to the second connector 80 piercing through the main body 81A and the connection portion 81B in the left-right direction. The single signal contact 82 and the two ground contacts 83 that all contain a metal material as respective configuring materials thereof are provided in the interior of the insulator 81.

As illustrated in FIG. 5, the signal contact 82 and the ground contacts 83 extend in straight lines along the X axis direction in front view of the antenna 50. Note that as long as the above “connectors” are able to connect the coaxial cable 90 and the antenna 50 together, they may be configured as a single integrally manufactured fixture instead of being configured as separate bodies such as the first connector 70 and the second connector.

Next, description follows regarding disposing the connectors to support the transmission line attached to the antenna 50. As illustrated in FIG. 4, a second straight line L2 is defined as being a straight line passing through the centroid 56B in a direction parallel to the X axis in front view of the antenna 50. In other words, the second straight line L2 is a straight line passing through the centroid 56B and orthogonal to the first straight line L1 in front view of the antenna 50. In such cases, as illustrated in FIG. 5, the connectors may be disposed such that in front view of the antenna 50, the signal contact 72, the ground contacts 73, the fixing members 74, the signal contact 82, and the ground contacts 83 are disposed at positions so as to be parallel to the second straight line L2, and such that the signal contact 72 and the signal contact 82 are positioned on the second straight line L2.

Note that reference here to parallel means that the signal contact 72, the ground contacts 73, the fixing members 74, the signal contact 82, and the ground contacts 83 are completely parallel, or substantially parallel, to the second straight line L2. Furthermore, in front view of the antenna 50, the two fixing members 74 and the two ground contacts 73 may be formed symmetrically with respect to the second straight line L2, and the two ground contacts 83 may be formed symmetrically with respect to the second straight line L2.

In particular, the two fixing members 74, which are metal members for fixing the connector (first connector 70) and the ground conductor plate 54 together, may have a profile extending in a direction substantially orthogonal to the vibration direction (Z axis direction) of the linearly polarized waves of the antenna 50, for example the vibration direction of vertically polarized waves. Furthermore, making the two fixing members 74 symmetrical with respect to the second straight line L2 in front view of the antenna 50 facilitates obtaining the desired antenna gain and directionality with the antenna 50. Note that in front view of the antenna 50 the widths (Z axis direction lengths) of the two fixing members 74 may be the same as each other, or different from each other, however when these widths are the same then they are formed symmetrical with respect to the second straight line L2, and this facilitates obtaining the above advantageous effects and so is preferable.

The coaxial cable 90 illustrated in FIG. 5 and FIG. 7 includes a signal line 91, an insulating body 92, an external conductor 93, and a protection cover 94. The circular cylindrical shaped insulating body 92 is provided at the peripheral outside of the signal line 91 configured from a conductor. One end portion of the coaxial cable 90 is inserted from a left end portion of the second connector 80 into the through hole mentioned above. Furthermore, the one end portion of the coaxial cable 90 and the second connector 80 are fixed together by a fixing means (omitted in the drawings). As illustrated in FIG. 5, the one end portion 91A of the signal line 91 is connected to the signal contact 82. Furthermore, the one end portion of the external conductor 93 is connected to the two ground contacts 83.

As illustrated in FIG. 5, the second connector 80 is integrated together with the first connector 70 by the connection portion 81B of the second connector 80 being inserted into the recess 71B of the first connector 70. Furthermore, the signal contact 82 contacts the left end portion of the signal contact 72, and each of the ground contacts 83 contacts a left end portion of the respective ground contacts 73.

As described above, the signal contact 72 contained in the first connector 70 is disposed so as to pass through the centroid 54A in front view of the antenna 50, however a connector contained in the first connector 70 is not limited to being disposed in this manner. For example, in cases in which the second conductor plate 55 does not include a planar shaped conductor line 57 nor a cut out 56X, and merely includes a radiation plate 56 having a square shape in front view of the antenna 50 and including the feeding point 56A1 in the interior of the radiation plate 56, then the connector may be fixed to the antenna 50 such that the signal contact 72 is not displaced from the centroid 54A. The connecting conductor 62 contained in the antenna 50 may be provided in the interior of a through hole passing from the feeding point 56A1 through the dielectric substrate 52 in the plate thickness direction thereof.

Namely, also in cases in which the second conductor plate 55 is configured in this manner, the front face 72A of the signal contact 72 is connected to the signal relay portion 54S, and this signal relay portion 54S may be disposed overlapping with the feeding point 56A1 (see FIG. 4) of the antenna 50 in front view of the antenna 50. When this occurs, the antenna 50 may be disposed so as, in front view of the antenna 50, to overlap with the front face 72A of the signal contact 72, the signal relay portion 54S, the feeding portion 60, the connecting conductor 62, and the feeding point 56A1.

Next, description follows regarding the antenna device 43 of the present exemplary embodiment including a cover member 95. As illustrated in FIG. 3, FIG. 5, and FIG. 6, the cover member 95, which protrudes from the ground conductor portion 54 of the antenna 50 toward the opposite side from the second conductor plate 55 side, is fixed to the antenna device 43. The cover member 95 is configured from a conductor such as copper or the like. In FIG. 6, the cover member 95 includes a first location 96, a second location 97, and a third location 98 that are each a flat plate. The second location 97 and the third location 98 are illustrated as rectangular shape flat plates having the same profile as each other.

However, the profiles of the first location 96, the second location 97, and the third location 98 may be shapes other than rectangular shapes. Furthermore in front view of the antenna 50, dimensions of the first location 96 may be the same as those of the dielectric substrate 52, or may be a wider width or may be a narrower width than the dielectric substrate. As illustrated in FIG. 3, in cases in which the antenna 50 is not equipped with a first element 66 or a second element 68, the X axis direction dimension of the first location 96 in the antenna device 43 may be the same as that of the first conductor plate 54 (the dielectric substrate 52). However, in cases in which the antenna 50 is equipped with the first element 66 and the second element 68 as illustrated in FIG. 4, the cover member 95 of the antenna device 43 may be disposed so as to overlap with all of these in front view of the antenna 50.

A front end portion of the second location 97 of the cover member 95 is connected to an upper edge portion 54U of the ground conductor portion 54, and a front end portion of the third location 98 is connected to a lower edge portion 54D of the ground conductor portion 54. The first location 96 is parallel to the ground conductor plate 54. Furthermore, the second location 97 and the third location 98 are parallel to each other, and are orthogonal to the ground conductor plate 54.

For the cover member 95 fixed to the ground conductor plate 54, in front view of the antenna 50, an upper edge portion of the first location 96 and the second location 97 overlap with the upper edge portion 54U of the first conductor plate 54, and a lower edge portion of the first location 96 and the third location 98 overlap with the lower edge portion 54D of the first conductor plate 54. In this manner, the second location 97 and the third location 98 are electrically connected to the ground conductor plate 54 and are also electrically connected to the first location 96, and the cover member 95 is grounded. Moreover, the first connector 70, the signal contact 82, and the ground contacts 83 also overlap with the first location 96 in front view of the antenna 50. Furthermore, positioning the second location 97 and the third location 98 further to the outer peripheral side than a peripheral edge portion of the radiation plate 56 in front view of the antenna 50 improves the antenna gain and directionality of the antenna device 43 and is accordingly preferable.

Moreover, when the antenna 50 and the cover member 95 are viewed along a row direction the second location 97 and third location 98 (the Z axis direction), then the first connector 70, the signal contact 82, and the ground contacts 83 overlap with the second location 97 and the third location 98. Furthermore, as illustrated in FIG. 6, when the antenna 50 and the cover member 95 are viewed along the X axis direction, the first connector 70, the signal contact 82, and the ground contacts 83 are positioned in a space 95S formed between the antenna 50 and the cover member 95. Namely, the ground conductor plate 54 and the cover member 95 that are electrically grounded are disposed so as to cover the periphery of the first connector 70 and the second connector 80. Furthermore, when the antenna 50 and the cover member 95 are viewed along the X axis direction, the first connector 70 is exposed through openings at both left and right ends of the cover member 95.

The antenna device 43 as described above is attached to an upper portion of a main face of the windshield 28 through a bracket (omitted in the drawings) and configures part of the vehicle antenna device 40. The first straight line L1 that passes through the feeding point 56A1 and the centroid 56B of the antenna 50 of the antenna device 43 is parallel to the Z axis, as illustrated in FIG. 4. Namely, in front view the first straight line L1 is parallel to a vibration direction Vd of vertically polarized waves that are able to be transmitted and received by the antenna 50. Moreover, in the vehicle antenna device 40, the antenna device 43 mounted to a vehicle includes the second location 97 of the cover member 95 positioned further upward than the third location 98. In particular, in the vehicle antenna device 40 the first location 96 of the cover member 95 may be attached so as to be substantially parallel to the vertical direction, and the second location 97 and the third location 97 may be attached so as to be substantially parallel to a horizontal plane.

Next, description follows regarding the angle of elevation and the angle of dip of the vehicle antenna device 40. As illustrated in FIG. 2, the vehicle antenna device 40 is appropriately installed such that an inclination angle α of the radiation face 56C of the radiation plate 56 with respect to a vertical direction 101 is in a range of ±15° when the front section of the vehicle 10 is viewed in side view (along the X axis direction). Moreover, as illustrated by the solid line in FIG. 2, a value of the inclination angle α is + (plus) when the radiation face 56C is positioned further rearward than the vertical direction 101. On the other hand, as illustrated by the dashed line in FIG. 2, the value of the inclination angle α is − (minus) when the radiation face 56C is positioned further forward than the vertical direction 101. In other words, when the inclination angle α exceeds 0°, the angle of elevation formed between the normal direction to the radiation face 56C of the radiation plate 56 and a horizontal plane exceeds 0° up to and including +15°.

Description now continues regarding an Example 1 that is a working example of the present exemplary embodiment, while comparing against an Example 2 that is a comparative example. Note that the antenna device 43 of Example 1 is assumed to be attached to the windshield 28 with conditions of θ1=22.5° and α=0°. A vehicle antenna device of a comparative example (omitted in the drawings) has the same structure as the antenna device 43, except in the point of not being equipped with the cover member 95.

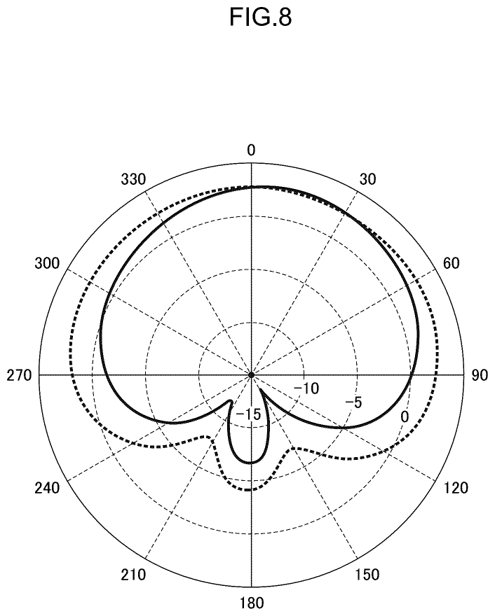

FIG. 8 illustrates measurement results of directionality of the antenna device 43 of Example 1 and of the antenna device of Example 2, with these being simulation results of antenna gain in the 5.9 GHz band for each direction in a horizontal plane. 0° indicates forward in the vehicle front-rear direction, 90° indicates the right side in the vehicle width direction, 180° indicates rearward in the vehicle front-rear direction, and 270° indicates the left side in the vehicle width direction. Note that the directionality indicated by the dashed line in FIG. 8 represents Example 1, the directionality indicated by the solid line therein represents Example 2, and units of antenna gain of FIG. 8 are “dBi”.

Reference signs L20, L21, L50, L51, L53, L55, L60, L62, L97, and L98 in FIG. 4 to FIG. 6 indicate each dimension (units: mm) of the antenna device 43 of Example 1 and the antenna device 40 of Example 2, and are as set out below. The directionalities of FIG. 8 are results when each portion is designed with these numerical values. Note that L55 is a distance in the Y axis direction between the first element 66 and the second element 68, and the radiation face 56C. Furthermore, the cover member 95 includes the second location 97 and the third location that are orthogonal to the first location 96, with the first location 96 having the same profile (L53×L60) as the ground conductor plate 54 in front view of the antenna 50.
L20: 13
L21: 13
L50: 19
L51: 1.5
L53: 20
L55: 2
L60: 20
L62: 1
L97: 11
L98: 11

Moreover, regarding the first connector 70 and the second connector 80 in Example 1 and Example 2, as illustrated in FIG. 5, the respective metal members are disposed so as to be symmetrical with respect to an (X axis direction) straight line (second straight line L2) passing through the centroid 54A of the ground conductor plate 54. Specifically, the signal contact 72 and the signal contact 82 are positioned on the second straight line L2, and the two fixing members 74 and the two ground contacts 73 and the two ground contacts 83 are disposed so as to be symmetrical with respect to the second straight line L2.

As illustrated in FIG. 8, antenna gain of the antenna device 43 of Example 1 in a range of from 0° to +90° and in a range of from 0° to 270° (−90°) was better than the antenna gain of the antenna device of Example 2 in a range of from 0° to +90° and in a range of from 0° to 270° (−90°). Furthermore, even in a range of from +90° to 120° and in a range of from 270° to 240° (−90° to −120°), the antenna gain of the antenna device 43 of Example 1 was better than the antenna gain of the antenna device of Example 2.

As described above, the first connector 70 of the antenna device 43 of the present exemplary embodiment includes metal members of the signal contact 72, the ground contacts 73, and the fixing members 74, and the second connector 80 includes metal members of the signal contact 82 and the ground contacts 83. These metal members are liable to change the antenna gain and directionality of the antenna device 43. However, in the antenna device 43 of the present exemplary embodiment, the periphery of the connectors (the first connector 70 and the second connector 80) is covered by the first conductor plate 54 and the cover member 95 when the antenna device 43 is viewed along the X axis direction. This means that the antenna device 43 of the present exemplary embodiment, serving as a working example, more easily obtains the desired antenna gain and directionality than the antenna device of the comparative example that lacks the cover member 95.

Furthermore, in front view of the antenna 50, in the antenna device 43 the signal contact 72 and the signal contact 82 are positioned on the second straight line L2. This means that in the antenna device 43 of Example 1, the signal contact 72 and the signal contact 82 are less liable to cause a fall in the antenna gain or disorder in directionality for the vertically polarized wave being transmitted and received by the antenna 50. Furthermore, in front view of the antenna 50, the two ground contacts 73 are formed so as to be symmetrical with respect to the second straight line L2, and the two ground contacts 83 are formed so as to be symmetrical with respect to the second straight line L2. This means that compared to cases in which the two ground contacts 73 and the two ground contacts 83 are not symmetrical, each of the ground contacts 73 and each of the ground contacts 83 of the present exemplary embodiment are less liable to cause a fall in the antenna gain or disorder in directionality for the vertically polarized wave being transmitted and received by the antenna 50. This means that the antenna device 43 of the present exemplary embodiment more easily obtains the desired antenna gain and directionality.

Note that in front view of the antenna 50, in the antenna device 43 widths (Z axis direction lengths) of the two ground contacts 73, 83 may be the same or may be different. When the widths of the two ground contacts 73, 83 are the same then they are formed symmetrically with respect to the second straight line L2, and so the above advantageous effect are obtained and is preferable. Moreover, the widths (Z axis direction lengths) of the signal contact 72 may be the same as or different from the widths of the ground contacts 73, 83, and they should be symmetrical with respect to the second straight line L2.

Although the present disclosure has been described by way of the exemplary embodiments, the present disclosure is not limited by these exemplary embodiments.

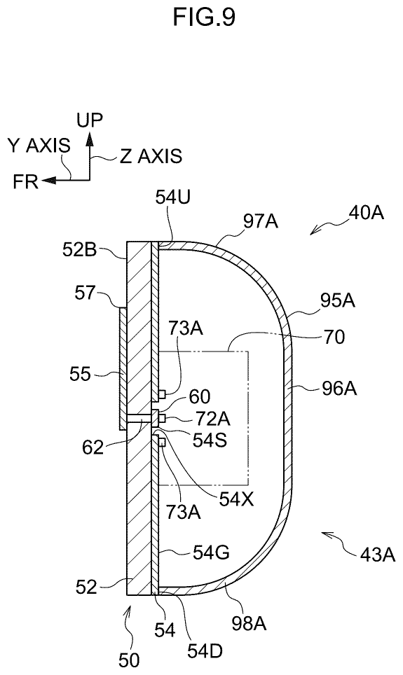

For example, the cover member 95 may have a different shape from that of the above exemplary embodiment as long as the periphery of the first connector 70 and the second connector 80 is able to be covered by the ground conductor plate 54 and the cover member 95 when the antenna device is viewed along the X axis direction. For example, an antenna device 43A of a modified example illustrated in FIG. 9 is equipped with a cover member 95A. Note that the vehicle antenna device 40A of the present modified example includes a windshield 28 (omitted from illustration in FIG. 9) and the antenna device 43A. This cover member 95A includes a first location 96A, a second location 97A, and a third location 98A. The first location 96A has a flat plate shape parallel or substantially parallel to a first conductor plate 54. The first location 96A opposes the first conductor plate 54 along the Y axis direction when the antenna device 43A is viewed along the X axis direction. The second location 97A and the third location 98A have a substantially circular arc shape when the antenna device 43A is viewed along the X axis direction. A front end portion of the second location 97A is soldered to an upper edge portion upper edge portion 54U of the ground conductor plate 54, and a front end portion of the third location 98A is soldered to a lower edge portion 54D of the ground conductor plate 54. The rear end portions of the second location 97A and the third location 98A of the cover member 95 are respectively connected to both the upper and lower end portions of the first location 96A. The antenna 50 of the antenna device 43A also more readily obtains the desired antenna gain and directionality than the antenna of the antenna device of the comparative example.

Moreover, in the antenna device 43, 43A, the cover member 95, 95A are open at both end portions in the extension direction of the signal contact 72, however at least part of two extension direction end portions of the cover member 95, 95A may be closed off. For example, in the antenna device 43, 43A, the right end portion of the cover member 95 of the above exemplary embodiment may be entirely closed off, with only the left end portion open. Moreover, for example, in the antenna device 43, 43A one portion of the right end portion of the cover member 95 may be closed off, and the left end portion may be entirely closed off. In FIG. 5, a member that closes of at least part of a right end portion and a left end portion of the cover member 95 may be freely selected, may be a conductor or may be a dielectric, and the shape thereof may be a plate shape and may a shape including indentations and protrusions.

When the antenna device 43 is viewed along the X axis direction, the second location 97 and the third location 98 of the cover member 95 are not necessarily orthogonal to the ground conductor plate 54. For example, the second location 97 and the third location 98 of the antenna device 43 may have an angle formed with respect to the ground conductor plate 54 that is an angle different from 90°, for example, a freely selected angle in a range of from 90°±20°. In such cases, in the antenna device 43 the ground conductor plate 54, the first location 96, the second location 97, and the third location 98 may be configured in a shape including a trapezoidal or a parallelogram shape when viewed along the X axis direction.

Moreover, in front view of the antenna 50, in the antenna device 43 the second location 97 may be positioned further downward than the upper edge portion 54U of the ground conductor plate 54, and the third location 98 may be positioned further upward than the lower edge portion 54D of the ground conductor plate 54. Furthermore, in front view of the antenna 50, in the antenna device 43 the front end portion of the second location 97A may be positioned further downward than the upper edge portion 54U of the ground conductor plate 54, and the front end portion of the third location 98A may be positioned further upward than the lower edge portion 54D of the ground conductor plate 54.

Note that a front end portion of the second location 97 of the cover member 95 may be configured not soldered to the ground conductor plate 54 and separated from the ground conductor plate 54. However, in such cases, a distance between the ground conductor plate 54 and the front end portion of the second location 97 needs to be set at a distance such that radio signals (electrical signals) can be relayed between the two. Similarly, as long as radio signals can be relayed with the ground conductor plate 54, a front end portion of at least one of the third location 98 of the cover member 95, the second location 97A of the cover member 95A, or the third location 98A of the cover member 95A may be configured so as not to be soldered to the ground conductor plate 54 and separated from the ground conductor plate 54.

The antenna device 43 including the antenna 50, the first connector 70, the second connector 80, the coaxial cable 90, and the cover member 95 may have a structure that is left-right symmetrical to the shape illustrated in FIG. 5. Namely, for the antenna device 43 illustrated in FIG. 5, the third portion 57C of the planar shaped transmission line 57 may be positioned further to the left side than the radiation plate 56, the second connector 80 and the coaxial cable 90 may be positioned at the right side of the first connector 70, and the tail portions 72A, 73A may be positioned at the left side of the insulator 71. Furthermore, connectors configuring the antenna device 43 should be at the same earth potential to an earth line of transmission lines such as the coaxial cable 90 and the like and to the ground conductor plate 54. In such cases, the two ground contacts 73, 83 are not necessary, and an earth line may be connected to any point on the ground conductor plate 54. However, the signal to be transmitted and received can be stably transmitted when the antenna device 43 includes the two ground contacts 73, 83 parallel to the signal contacts 72, 73.

As illustrated in FIG. 1 and FIG. 2, the antenna device 43 or the antenna device 43A may be attached to a vehicle up-down direction upper portion of a main face (front face) at a vehicle cabin inside of the rear glass (vehicle window glass) 34 through a non-illustrated bracket.

In cases in which the antenna device 43 or the antenna device 43A is provided to the rear glass 34 of the vehicle 10, the antenna device 43 or the antenna device 43A may or may not be provided to the windshield 28 of the vehicle 10. In cases in which the antenna device 43 or the antenna device 43A is provided to windshield 28 and also the antenna device 43 or the antenna device 43A is provided to the rear glass 34 in the manner illustrated in FIG. 1, then the desired antenna gain can be implemented in a range of from 0° to 360° in a horizontal plane by a combined value of the antenna gain of the front antenna 50 and the rear antenna 50.

Furthermore, the antenna 50 may be a horizontal polarized wave antenna having a higher antenna gain for transmitting and receiving horizontally polarized waves than for vertically polarized waves. In such cases, in front view preferably the antenna device 43 or the antenna device 43A is attached to the vehicle 10 such that the first straight line L1 is parallel to the X axis direction.

In cases in which the antenna devices 43, 43A are each a vertically polarized wave antenna, the vehicle antenna device 40 may be configured with the antenna device 43, 43A provided to the vehicle 10 such that an angle formed between the straight line L1 and the vertical direction is not greater than 15° in front view of the antenna 50. Moreover, in cases in which the antenna devices 43, 43A are each a horizontal polarized wave antenna, the vehicle antenna device 40 may be configured with the antenna device 43, 43A provided to the vehicle 10 such that an angle formed between the straight line L2 and the vertical direction is not greater than 15° in front view.

Moreover, the antenna 50 may be configured so as to be capable of transmitting and receiving circular polarized waves or elliptically polarized waves.

Furthermore, plural of the antenna devices 43, 43A may be attached to the windshield 28. Similarly, plural of the antenna devices 43, 43A may be attached to the rear glass 34.

Moreover, the rear glass 34 may be provided to a back door (omitted in the drawings) that opens and closes off an opening provided to a rear section of the vehicle 10.

What is claimed is:

1. An antenna device comprising:
a dielectric substrate;
an antenna including a radiation plate that is provided on a first main face of the dielectric substrate and that includes a radiation face radiating radio waves of a prescribed frequency band, and including a ground conductor plate that is disposed on a second main face of the dielectric substrate;
a connector that is provided to a face of the ground conductor plate on an opposite side from a radiation plate side, that includes a metal member, that is fixed to the antenna, and that supports a transmission line; and
a cover member that opposes a face of the ground conductor plate on the opposite side from the radiation plate side and that is configured from an electrically grounded conductor, wherein:
a position of a feeding point on the radiation plate is different from a position of a centroid of the radiation plate, in a front view of the antenna; and
the antenna and the cover member cover a periphery of the connector when the antenna, the connector, and the cover member are viewed along a direction orthogonal to a first straight line connecting the centroid to the feeding point and orthogonal to a thickness direction of the dielectric substrate.

2. The antenna device of claim 1, wherein in front view of the antenna, part of the cover member is positioned at a further to an outer peripheral side than a peripheral edge portion of the radiation plate.

3. The antenna device of claim 1, wherein the antenna includes at least one parasitic conductor plate at a different position from the centroid of the radiation plate, when viewed along the thickness direction of the dielectric substrate.

4. The antenna device of claim 3, wherein:
the antenna includes two of the parasitic conductor plates positioned further to the radiation plate side than the ground conductor plate; and
the radiation plate is positioned between the two parasitic conductor plates in front view of the antenna.

5. The antenna device of claim 4, wherein the two parasitic conductor plates are reciprocally further outside than the ground conductor plate in front view of the antenna.

6. The antenna device of claim 1, wherein:
the cover member includes a first location that opposes the ground conductor plate and the connector in a thickness direction of the dielectric substrate and that is parallel to the radiation plate, and includes a second location and a third location that are electrically connected to the first location and to the ground conductor plate; and
the connector is positioned between the second location and the third location.

7. The antenna device of claim 6, wherein the second location and the third location are respectively connected to each end portion of the ground conductor plate and are formed parallel to each other.

8. The antenna device of claim 7, wherein the second location and the third location are orthogonal to the first location.

9. The antenna device of claim 1, wherein:
when the antenna, the connector, and the cover member are viewed along a direction orthogonal to the first straight line and orthogonal to the thickness direction of the dielectric substrate, the cover member exposes a space formed between the cover member and the ground conductor plate.

10. The antenna device of claim 9, wherein the metal member is disposed parallel to a second straight line orthogonal to the first straight line and passing through the centroid in plan view of the antenna.

11. The antenna device of claim 10, wherein a pair of the metal members are provided to the connector as fixing members fixed to the ground conductor plate, and the pair of fixing members are formed so as to have line symmetry to each other with respect to the second straight line.

12. The antenna device of claim 10, wherein the transmission line is connected to the connector such that at least part of the transmission line is formed parallel to the second straight line and overlapping with the second straight line.

13. The antenna device of claim 12, wherein a signal contact of the transmission line extends overlapping with the second straight line.

14. The antenna device of claim 13, wherein a pair of ground contacts of the transmission line are formed so as to have line symmetry to each other with respect to the second straight line.

15. The antenna device of claim 1, wherein:
the antenna includes a planar shaped conductor line positioned on a flat plane where the radiation face is positioned;
the planar shaped conductor line includes a first end portion that is connected to the feeding point, and a second end portion that is positioned on a second straight line orthogonal to the first straight line and passing through the centroid; and
the first end portion is electrically connected to a signal line of the transmission line.

16. A vehicle antenna device comprising:
a vehicle window glass provided in a vehicle; and
the antenna device of claim 1, disposed such that the radiation face opposes the vehicle window glass, wherein
an angle formed between the radiation face and a vertical direction of the vehicle is in a range of ±15°.

17. The vehicle antenna device of claim 16, wherein:
the cover member includes a first location that opposes the ground conductor plate and the connector in the thickness direction and that is parallel to the radiation plate, and includes a second location and a third location that are separated from each other in a direction parallel to the first straight line and that are connected to the first location; and
one of the second location or the third location is positioned further upward than the other thereof.

18. The vehicle antenna device of claim 16, wherein the antenna is a V2X antenna.
